(19) United States
(12) Patent Application Publication
(10) Pub. No.: US 2016/0114475 A1
(43) Pub. Date: Apr. 28, 2016

(54) SEAT DEVICE WITH SUCKING BASE FOR TOOL

(71) Applicant: CYUAN HUNG INDUSTRIAL CO., LTD., Taichung City (TW)

(72) Inventor: CHUN-MEI TANG, Taichung City (TW)

(21) Appl. No.: 14/522,523

(22) Filed: Oct. 23, 2014

(51) Int. Cl. B25H 3/04

(52) U.S. Cl. CPC B25H 3/04

(57) ABSTRACT

A seat device with sucking base for tool is provided, including an inserting column and a sucking portion. The inserting column has an inserting portion formed with at least one inserting hole, and each inserting hole is provided for at least one rod-shaped tool to insert therein. The sucking portion is disposed at an end of the inserting column opposite to the inserting portion. The sucking portion has a concave sucking face, and none of the at least one inserting hole is open on the sucking face.

### BACKGROUND OF THE INVENTION

1. Field of the Invention

The present invention relates to a sucking base, and more particularly to a seat device with sucking base for tool.

2. Description of the Prior Art

The conventional way of storing rod-shaped tools is putting the rod-shaped tools in different dimensions in a toolbox so as to manage or carry the rod-shaped tools. When a user wants to use the rod-shaped tools, s/he opens the toolbox to find the rod-shaped tool in the dimension s/he needs.

However, in this kind of conventional arts, when the toolbox is not used or is put in a construction site, the user needs to find a horizontal place to put the toolbox. In addition, when the toolbox receives unexpected impact, the arrangement of the rod-shaped tools in the toolbox will be out of order. If the toolbox is flipped over, the rod-shaped tools in the toolbox will be scattered all over.

The present invention is, therefore, arisen to obviate or at least mitigate the above-mentioned disadvantages.

### SUMMARY OF THE INVENTION

The main object of the present invention is to provide a seat device with sucking base for tool which allows a user to categorize rod-shaped tools in different dimensions effectively and fixedly and to take the rod-shaped tool s/he needs quickly. In addition, the present invention can be positioned on planes in different angles, instead of a horizontal plane, casually and stably; therefore, the present invention can be positioned in a place near the user to make it convenient for the user to take the rod-shaped tools.

To achieve the above and other objects, a seat device with sucking base for tool of the present invention is provided, including an inserting column and a sucking portion. The inserting column has an inserting portion formed with at least one inserting hole, and each inserting hole is provided for at least one rod-shaped tool to insert therein. The sucking portion is disposed at an end of the inserting column opposite to the inserting portion. The sucking portion has a concave sucking face, and none of the at least one inserting hole is open on the sucking face.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1A is a sketch showing a whole structure of a preferred embodiment of the present invention;

FIG. 1B is a sketch showing a structure of a sucking portion of the preferred embodiment of the present invention;

FIG. 2 is a side cross-sectional view of the preferred embodiment of the present invention;

FIG. 3 is an assembling sketch of the preferred embodiment of the present invention;

FIG. 4 is a cross-sectional view of the preferred embodiment of the present invention in use;

FIG. 5 is a sketch of the preferred embodiment of the present invention in use;

FIG. 6 is a cross-sectional view of another embodiment of the present invention in use;

FIG. 7 is an assembling sketch of still another preferred embodiment of the present invention; and

FIG. 8 is a side cross-sectional view of still another preferred embodiment of the present invention.

### DETAILED DESCRIPTION OF THE PREFERRED EMBODIMENTS

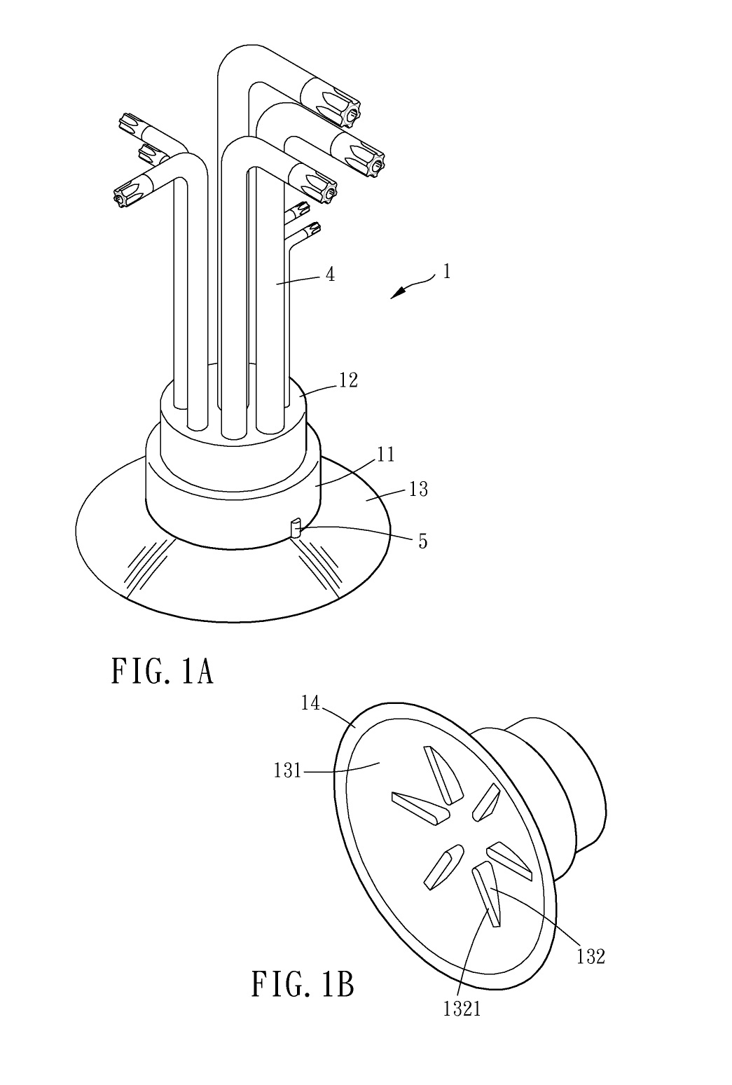

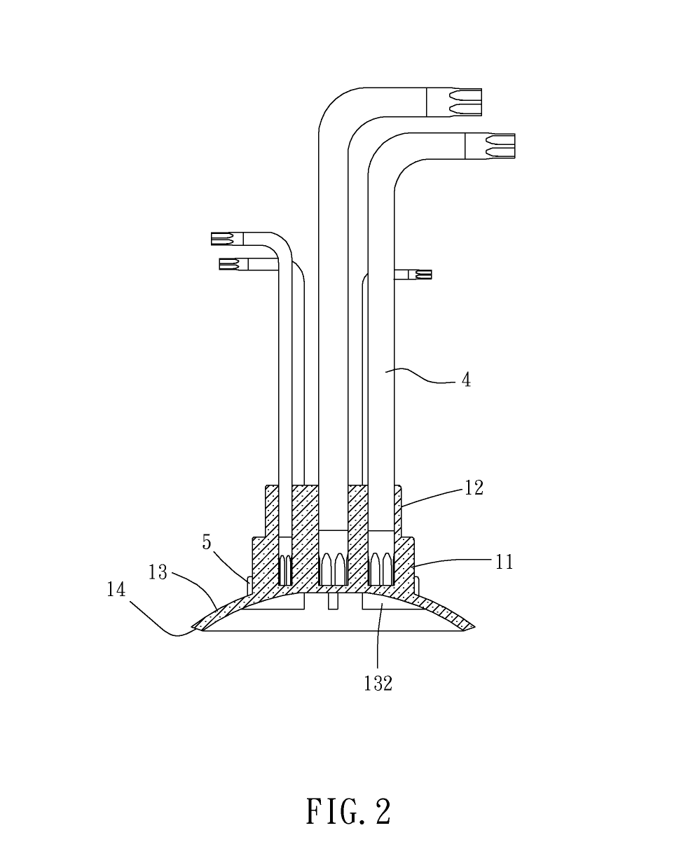

Please refer to FIGS. 1A, 1B to FIG. 5 for a preferred embodiment of the present invention. A seat device with sucking base for tool of the present invention includes an inserting column 11 and a sucking portion 13.

The inserting column 11 has an inserting portion 12 formed with at least one inserting hole 111, and each inserting hole 111 is provided for at least one rod-shaped tool 4 (for example, a hexagonal wrench or a rod-shaped tool head) to insert therein. Preferably, a depth of the at least one inserting hole 111 is equal to or greater than an ½ axial dimension of the inserting column 11; therefore, even if the present invention receives unexpected impact, the at least one tool 4 can be firmly held on the inserting column 11 and not easy to detach from the inserting column 11. In addition, each inserting hole 11 can have different shapes in accordance with a radial shape of different tools 4; therefore, it is convenient to insert each tool 4 into each inserting hole 111, and it is easy to pull out each tool 4 when the a user wants to use each tool 4. Preferably, the inserting column 11 is made of a material with high elasticity; therefore, when a diameter of the inserting column 11 is smaller than a radial dimension of each tool 4 to be inserted therein, each inserting hole 111 can elastically restrict each tool 4 and make each tool 4 stably fixed. It is understandable that a whole structure of the seat device with sucking base for tool 1 is made of the same material with high elasticity.

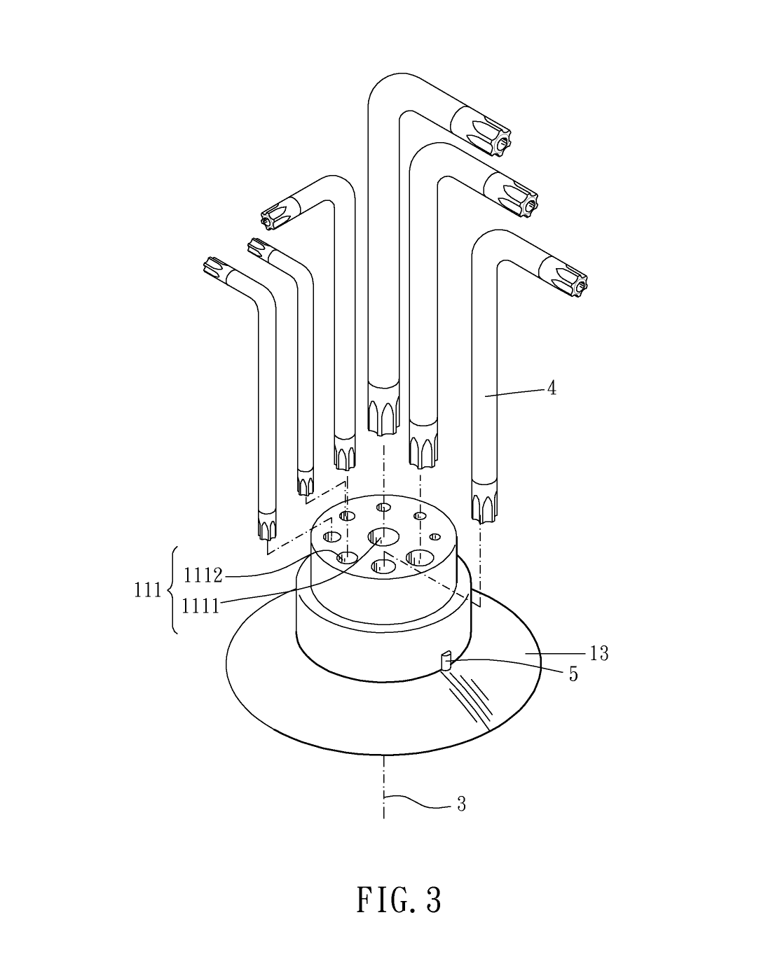

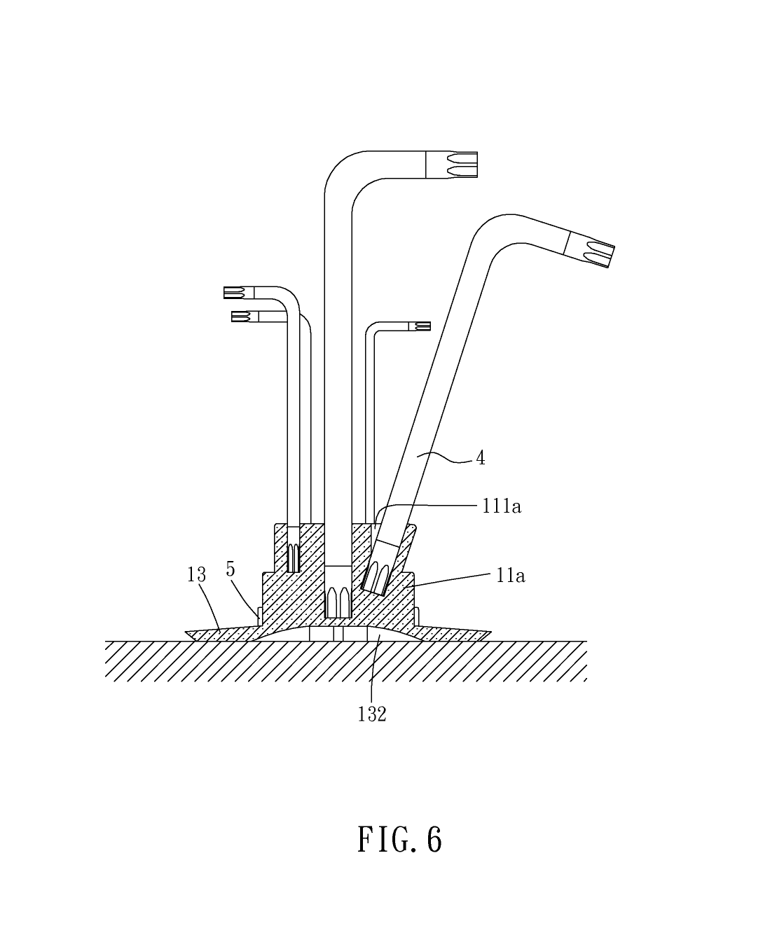

When the inserting portion 12 has a plurality of the inserting holes 111, there can be different ways of arrangement. In this embodiment, as shown in FIG. 3, the inserting holes 111 include a central inserting hole 1111 and at least one circumferential inserting hole 1112 disposed neighboring to the central inserting hole 1111. A diameter of the central inserting hole 1111 is larger than a diameter of any of the at least one circumferential inserting hole 1112. The central inserting hole 1111 has the larger diameter; therefore, when the present invention receives unexpected impact, the tool 4 in the central inserting hole 1111 can remain stable; and when the tool 4 in the central inserting hole 1111 is slanted due to the impact, the whole inserting column 11 will not be influenced and shake easily; therefore, inserting one said tool 4 in a larger radial dimension in the central inserting hole 1111 makes the present invention more stable. Please further refer to FIG. 6 for a plurality of inserting holes 111a of another embodiment. Aside from the inserting holes 111a having different diameters, one said inserting hole 111a having a relatively larger diameter has a relatively deeper depth than any other, and at least one of the depths of the inserting holes 111a is equal to or greater than an ½ axial dimension of the inserting column 11a.

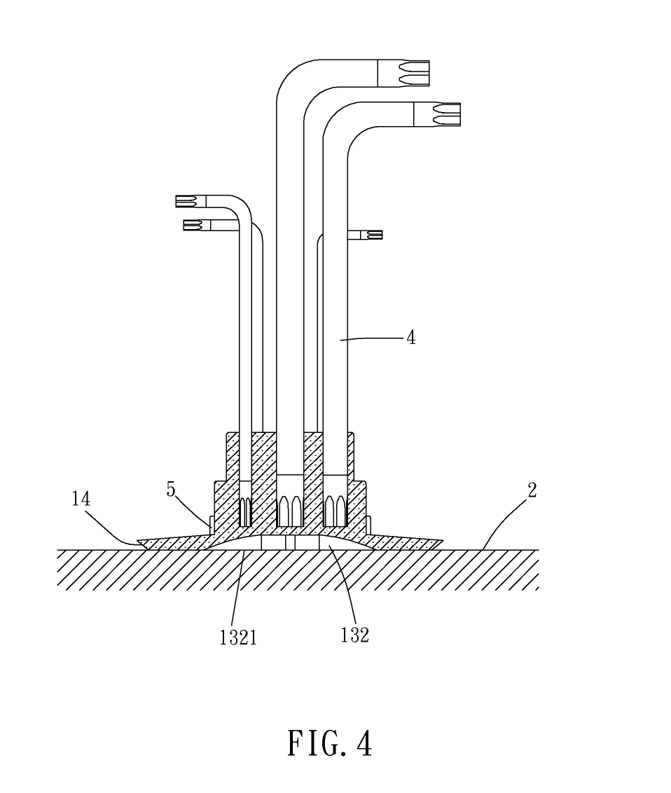

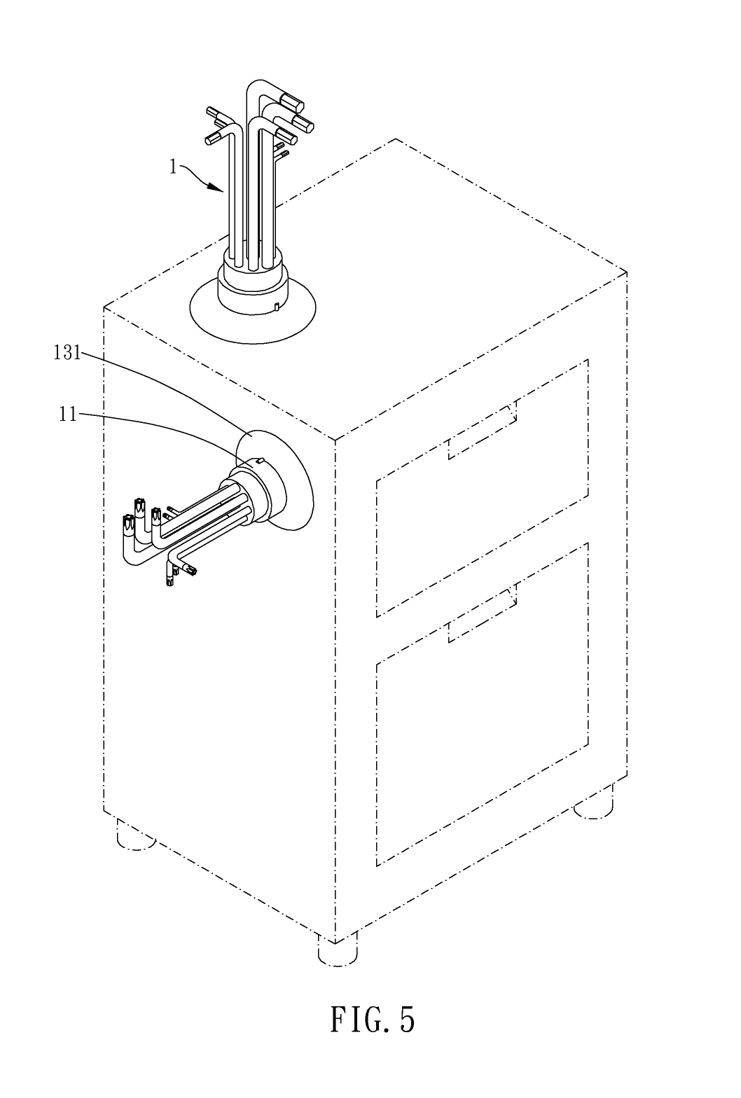

Please further refer to FIGS. 4 and 5. The inserting column 11 and the sucking portion 13 are integrally formed, and the sucking portion 13 is disposed at an end of the inserting column 11 opposite to the inserting portion 12. The sucking portion 13 has a concave sucking face 131, and none of the at least one inserting hole 111 is open on the sucking face 131. The seat device with sucking base for tool 1 can be stably positioned on different planes 2 (for example, a plane 2 can be horizontal, vertical or in other degrees) via the sucking face 131. In addition, the seat device with sucking base for tool 1 further has a lifting portion 14 disposed along a circumferential edge of the sucking face 131, and the lifting portion 14 is slanted from a side by which the inserting column 11 is located to a side by which the sucking face 131 is located and from outward to inward. When the sucking face 131 sucks on a plane 2, the lifting portion 14 does not contact with the plane 2, and the user can take or move the seat device with sucking base for tool 1 by gently lifting the lifting portion 14.

Preferably, the sucking face 131 is further formed with at least one rib portion 132, and each rib portion 132 has a supporting face 1321. When the sucking face 131 sucks on a plane 2, the supporting face 1321 abuts against the plane 2, wherein the at least one rib portion 132 extends radially on the sucking face 131, but not limited thereto, and the at least one rib portion 132 can also extend axially and be arranged on the sucking face 131. Specifically, the seat device with sucking base for tool 1 includes a plurality of the rib portions 132, and the rib portions 132 are arranged around and relative to the an axle 3 of the inserting column 11. In this embodiment, the seat device with sucking base for tool 1 has six the rib portions 132, and the rib portions 132 are arranged symmetrically relative to the axle 3. Therefore, the rib portions 132 can not only provide more stable supporting force but also restrict a swinging range of the inserting column 11 so as to make the sucking face 131 stably contact with the plane 2 and make the sucking face 131 not detach from the plane 2 due to unexpected situations. In other embodiments, the rib portions 132 can be arranged on the sucking face 131 evenly in odd number.

Preferably, in view along an axial direction of the inserting column 11, the at least one inserting hole 111 at least corresponds to one said rib portion 132, and the rib portion 132 provides the supporting force directly to the tool 4 inserted in the inserting hole 111 corresponding to the rib portion 132 so as to allow the tool 4 to be inserted in the inserting hole 111 stably. In addition, preferably, a connecting portion of the inserting column 11 and the sucking portion 13 is formed with at least one supporting member 5, and each supporting member 5 corresponds to one said rib portion 132. In this embodiment, the seat device with sucking base for tool 1 has two the supporting members 5. When the inserting column 11 swings, each supporting member 5 abuts against each corresponding rib portion 132 to support the inserting column 11; therefore, the sucking face 131 will not detach from the plane 2 because the inserting column 11 overswings, and the seat device with sucking base for tool 1 can be prevented from tilting or falling off. In addition, each supporting member 5 can reinforce a connection of the sucking portion 13 and the inserting column 11, so the sucking portion 13 and the inserting column 11 won't be separated easily. In other embodiments, in order to have preferable supporting effect, the supporting member 5 can be arranged on the connecting portion of the inserting column 11 and the sucking portion 13 and corresponding to each rib portion 132.

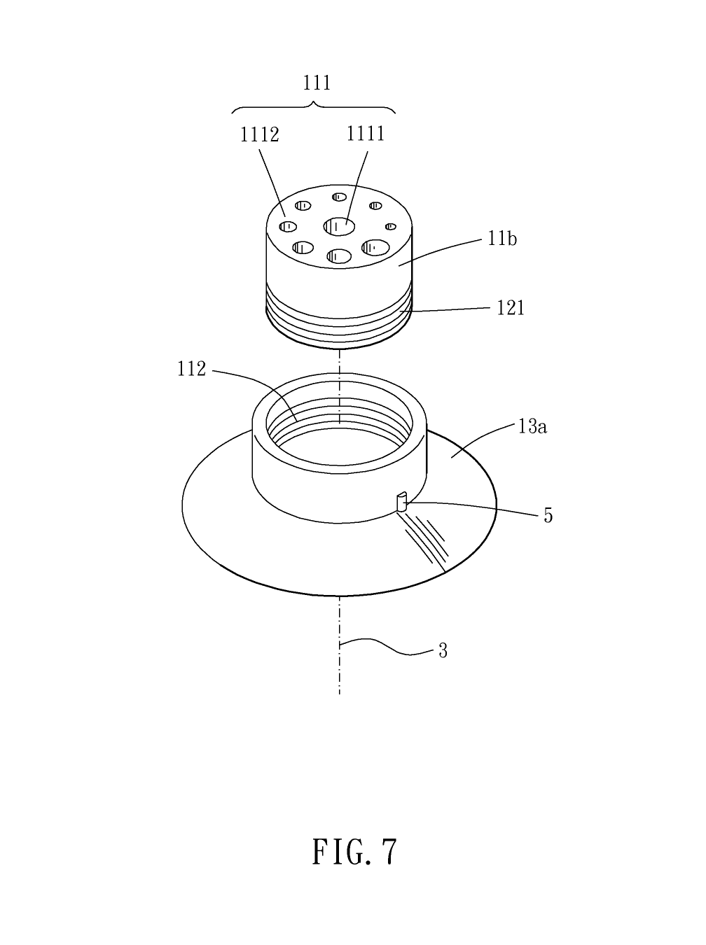

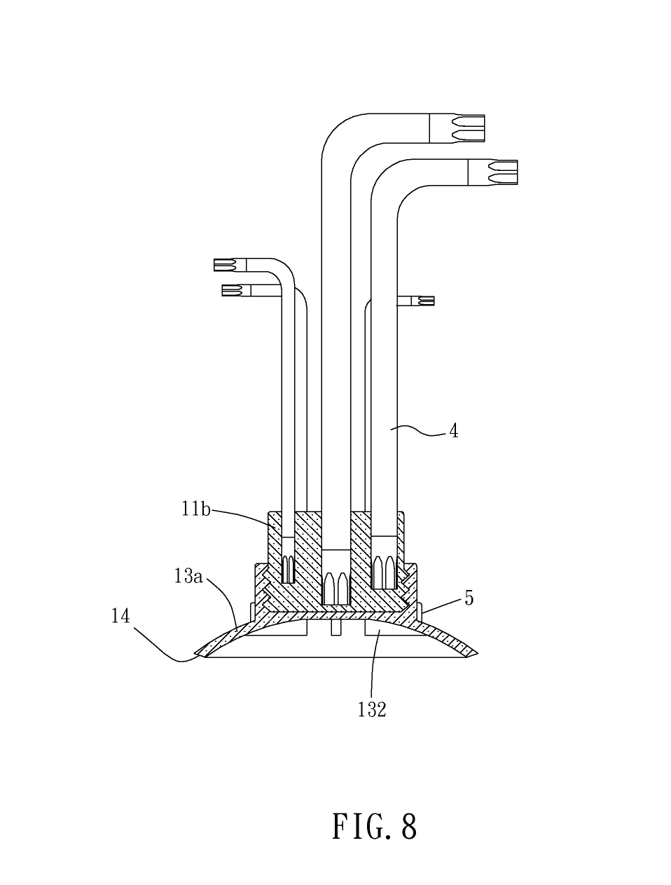

Please refer to FIGS. 7 and 8 for an inserting column 11b and a sucking portion 13a of still another preferred embodiment. The inserting column 11b and the sucking portion 13a are screwed with each other. One of the inserting column 11b and the sucking portion 13a has an inner threaded portion 112, and the other of the inserting column 11b and the sucking portion 13a has an outer threaded portion 121 for screwing with the inner threaded portion 112; therefore, the inserting column 11b is detachably connected to the sucking portion 13a. Thereby, when the user wants to insert the tool 4 in different shapes or dimensions, s/he only needs to change the inserting column 11b; or when the inserting portion 12 is damaged due to long-term use, the user only needs to change the inserting column 11b instead of a whole set of the seat device with sucking base for tool 1. It is understandable that the inserting column 11b and the sucking portion 13a can also be connected to each other by engaging as long as the inserting column 11b is detachably connected to the sucking portion 13a.

Given the above, the seat device with sucking base for tool of the present invention is provided for tools to insert therein through disposing at least one inserting hole on the inserting column. When a plurality of inserting holes with different diameters is disposed, the tools in different radial dimensions can be categorized; therefore, the user can take the tool s/he needs quickly and easily without extra assembly.

In addition, the seat device with sucking base for tool can be positioned on any plane in any degrees via the sucking portion, so the seat device with sucking base for tool can be put near the user when the user wants to use it. The seat device with sucking base for tool can solve the problem of storage effectively.

Furthermore, there is a plurality of rib portions arranged on the sucking face to provide extra supporting force, so the tools can be inserted in the inserting column stably, and the inserting column can be restricted and won't shake. Besides, the supporting member is disposed on the connecting portion of the inserting column and the sucking portion to make the inserting column more stable.

Although particular embodiments of the invention have been described in detail for purpose of illustration, various modifications and enhancements may be made without departing from the spirit and scope of the invention. Accordingly, the invention is not to be limited except as by the appended claims.

What is claimed is:

1. A seat device with sucking base for tool, including:
an inserting column, having an inserting portion formed with at least one inserting hole, each inserting hole provided for a rod-shaped tool to insert therein; and
a sucking portion, disposed at an end of the inserting column opposite to the inserting portion, having a concave sucking face, none of the at least one inserting hole being open on the sucking face.

2. The seat device with sucking base for tool of claim 1, wherein the sucking face further has at least one rib portion, each rib portion has a supporting face, and when the sucking face sucks on a plane, the supporting face abuts against the plane.

3. The seat device with sucking base for tool of claim 2, wherein the at least one rib portion extends radially on the sucking face.

4. The seat device with sucking base for tool of claim 3, wherein the seat device includes a plurality of the rib portions, and the rib portions are arranged relative to and around an axle of the inserting column.

5. The seat device with sucking base for tool of claim 1, further including a lifting portion disposed along a circumferential edge of the sucking face, wherein the lifting portion is slanted from a side by which the inserting column is located to a side by which the sucking face is located and from outward to inward, and when the sucking face sucks on a plane, the lifting portion uncontacts with the plane.

6. The seat device with sucking base for tool of claim 2, wherein in view along an axial direction of the inserting column, the at least one inserting hole at least corresponds to one said rib portion.

7. The seat device with sucking base for tool of claim 2, wherein a connecting portion of the inserting column and the sucking portion is formed with at least one supporting member, and each supporting member corresponds to one said rib portion.

8. The seat device with sucking base for tool of claim 1, wherein a depth of the at least one inserting hole is equal to or greater than an ½ axial dimension of the inserting column.

9. The seat device with sucking base for tool of claim 1, wherein each inserting hole restricts each tool elastically.

10. The seat device with sucking base for tool of claim 1, wherein the inserting portion has a plurality of the inserting holes, the inserting holes include a central inserting hole and at least one circumferential inserting hole disposed neighboring to the central inserting hole, and a diameter of the central inserting hole is larger than a diameter of any of the at least one circumferential inserting hole.

11. The seat device with sucking base for tool of claim 10, wherein the inserting holes have different diameters, one said inserting hole having a relatively larger diameter has a relatively deeper depth than any other, and at least one of the depths of the inserting holes is equal to or greater than an ½ axial dimension of the inserting column.

12. The seat device with sucking base for tool of claim 1, wherein the inserting column and the sucking portion are integrally formed.

13. The seat device with sucking base for tool of claim 1, wherein the inserting column is detachably connected to the sucking portion.

14. The seat device with sucking base for tool of claim 13, wherein the inserting column and the sucking portion are screwed with each other, one of the inserting column and the sucking portion has an inner threaded portion, and the other of the inserting column and the sucking portion has an outer threaded portion for screwing with the inner threaded portion.
